(19) United States
(12) Patent Application Publication
(10) Pub. No.: US 2014/0022180 A1
(43) Pub. Date: Jan. 23, 2014

(54) Method for Inputting and Searching Chinese Characters with Easy-Strokes

(71) Applicants: Wei Yan, Beijing (CN); Haidi Zhang, Beijing (CN)

(72) Inventors: Wei Yan, Beijing (CN); Haidi Zhang, Beijing (CN)

(73) Assignee: Beijing Farfir Intellectual Property Agency, Beijing (JP)

(21) Appl. No.: 13/823,135

(22) PCT Filed: Sep. 9, 2011
(86) PCT No.: PCT/CN11/79546

§ 371 Date: Sep. 26, 2013

(30) Foreign Application Priority Data
Sep. 14, 2010 (CN) 201010280782.0

(51) Int. Cl. G06F 3/01

(52) U.S. Cl. CPC G06F 3/018
USPC 345/171

(57) ABSTRACT

Disclosed is a method for inputting and searching Chinese characters with Easy-Strokes, wherein the complex strokes of Chinese characters are broken down into simple strokes without any angle (or vertex) and a said simple stroke is identified as an Easy-Stroke. The feature information of Easy-Strokes for a Chinese character consists of the total stroke number of Easy-Strokes, the stroke types of Easy-Strokes, the stroke types of Easy-Strokes at the special locations of a character, and the stroke numbers of different types of Easy-Strokes. A correspondence is established between the feature information of Easy-Strokes and the corresponding input components on a device to implement the input of Chinese characters. A Chinese character database is established according to the feature information of Easy-Strokes to implement the search of Chinese characters. The present invention simplifies complex strokes of Chinese characters and enables users to easily input Chinese characters without memorizing a large number of complex rules, and basic knowledge of mapping between keyboard codes and root characters. In addition, its operation is simple and convenient because users may choose to input the feature information of Easy-Strokes for a Chinese character in any sequence and combination. Thus, both Chinese and non-Chinese can easily adopt the method.

### TECHNICAL FIELD

This invention regards the method for inputting and searching Chinese characters. Specifically, this method involves Chinese character Easy-Strokes.

### BACKGROUND ART

Chinese characters are within the scope of linguistics. Each Chinese character contains three properties of linguistic information, i.e. shape, pronunciation and meaning. The method for inputting Chinese characters is used to enter Chinese characters. All existing Chinese character input methods can be divided into three categories: the methods based on graphic shape information, the methods based on pronounced pinyin information, and the methods based on a combination of both graphic shape and pronounced pinyin information. These three categories have the corresponding shape coding, pinyin coding, and shape-pinyin coding systems respectively. They are applied for particular situations. Pinyin coding and shape-pinyin coding are suitable for people with the knowledge of the pronunciation of the character; whereas, shape coding can be used by people who only know the shape of a Chinese character without any knowledge of its pronunciation or meaning.

Chinese character input method is mainly used by Chinese people. However, with the global “Chinese rush”, more and more foreigners are learning the Chinese language. For those foreign students who just started to learn Chinese, it is nearly impossible to use pinyin coding and shape-pinyin coding methods. Shape coding method usually has complex rules and a large amount of character roots to be memorized Thus, it is usually difficult to master. For example, the Five Stroke Typing Method uses five basic strokes (i.e. “horizontal bar”, “vertical bar”, “slash”, “back slash”, “hook”), and 130 (1986 version)/245 (1998 version) character roots, as well as the rule of its usage based on Six Code Symbols & the Right Hand Rule with the mapping between character roots and 25 stroke keys for typing. The Five Stroke Typing Method is suitable for quickly entering Chinese characters. Generally a user needs professional training to master it due to its complexity. Additionally, Chinese characters have about 200 radicals which represent creative properties of character groups, and about 30 strokes which were formed according to calligraphy and handwriting customs. Not only are radicals and strokes difficult to grasp for all foreign learners of the Chinese language, but also even for native Chinese speakers.

Therefore, a simple, intuitive method for inputting Chinese characters is needed. It can aid users in inputting Chinese characters based on the characteristics of graphic shape of Characters without being familiar with pronunciations and radicals of the Chinese characters. Meanwhile, a simple, intuitive method for searching Chinese characters is also helpful for users, especially for Chinese language beginners.

### DISCLOSURE

This invention is intended for the above technical issues, and disclosed is the design and development of the approach for inputting and searching Chinese characters with Easy-Strokes.

The purpose of this invention is to provide the method for inputting Chinese characters with Easy-Strokes. In this input method, the traditional strokes of Chinese characters are decomposed and inducted into simple strokes without any angle (or vertex), and each said simple stroke is identified as one Easy-Stroke. The total stroke number of Easy-Strokes, the stroke types of Easy-Strokes, the stroke types of Easy-Strokes at the special locations in a character, and the stroke numbers of different types of Easy-Strokes constitute all feature information of Easy-Strokes for Chinese characters. The above feature information of Easy-Strokes can fully represent characteristics of Chinese character shapes. A correspondence is established between the feature information of Easy-Strokes and the corresponding input components on a device to implement the input of Chinese characters.

Another purpose of this invention is to provide the method for searching Chinese characters with Easy-Strokes. In this method, strokes of Chinese characters are decomposed and inducted into Easy-Strokes without any angle (or vertex). The total stroke number of Easy-Strokes, the stroke types of Easy-Strokes, the stroke types of Easy-Strokes at the special locations in a character, and the stroke numbers of different types of Easy-Strokes constitute all feature information of Chinese characters. The above feature information of Easy-Strokes can fully represent characteristics of Chinese character shapes. The feature information of Easy-Strokes can be used to search Chinese characters in the Chinese character database.

This invention provides technical solutions for:

A method for inputting Chinese characters with Easy-Strokes, wherein comprising following steps:

Step I: According to the stroke principle of Easy-Strokes, a simple stroke without any angle (or vertex) is defined as one Easy-Stroke;

Step II: A complex stroke with at least one angle (or vertex) is separated, at the angle point(s) (or vertices), into multiple simple strokes without any angle (or vertex), each said simple stroke is defined as one Easy-Stroke;

Step III: Entering the total stroke number of Easy-Strokes derived from the Step I and Step II through a corresponding input component on an appropriate input device to implement the input of Chinese characters.

The method for inputting Chinese characters with Easy-Strokes as described above, wherein the said input device can be a number key or a combination of number keys as the input component on the keyboard for entering the stroke number for each stroke type of Easy-Strokes to implement the input of Chinese characters.

The method for inputting Chinese characters with Easy-Strokes as described above, wherein Step III further comprising: determining the feature codes for stroke types of Easy-Strokes derived from Step I and Step II, entering the total number of Easy-Strokes calculated from Step I and Step II and feature codes for stroke types of Easy-Strokes for at least one special location of the Chinese character through the input components on the keyboard to implement the input of Chinese characters.

The method for inputting Chinese characters with Easy-Strokes as described above, wherein Step III further comprising: determining feature codes for stroke types of Easy-Strokes and calculating the stroke numbers for different stroke types of Easy-Strokes derived from Step I and Step II, and entering feature codes for stroke types of Easy-Strokes with the corresponding stroke number for each stroke type through the input components on the keyboard to implement the input of Chinese characters.

The method for inputting Chinese characters with Easy-Strokes as described above, wherein Step III further comprising: determining feature codes for stroke types of Easy-Strokes and calculating the stroke numbers for different stroke types of Easy-Strokes derived from Step I & II, and entering the total number of Easy-Strokes in a Chinese character and feature codes for stroke types of Easy-Strokes with the corresponding stroke number for each stroke type through the input components on the keyboard to implement the input of Chinese characters.

The method for inputting Chinese characters with Easy-Strokes as described above, wherein Step III further comprising: determining feature codes for stroke types of Easy-Strokes and calculating the stroke numbers for different stroke types of Easy-Strokes derived from Step I and Step II, and entering feature codes for stroke types of Easy-Strokes with the corresponding stroke number for each stroke type and feature codes for stroke types of Easy-Strokes for at least one special location of the Chinese character through the input components on the keyboard to implement the input of Chinese characters.

The method for inputting Chinese characters with Easy-Strokes as described above, wherein Step III further comprising: determining feature codes for stroke types of Easy-Strokes and calculating the stroke numbers for different stroke types of Easy-Strokes and the total number of Easy-Strokes derived from Step I and Step II, and entering the total number of Easy-Strokes in a Chinese character, the feature codes for stroke types of Easy-Strokes for at least one special location of the Chinese character, and feature codes for stroke types of Easy-Strokes with the corresponding stroke number for each stroke type through the input components on the keyboard to implement the input of Chinese characters.

The method for inputting Chinese characters with Easy-Strokes as described above, wherein Step III further comprising: inputting hand-written image of Easy-Strokes derived from Step I and Step II by using an image input equipment, and identifying the number and type of Easy-Strokes with pattern recognition to implement the input of Chinese characters.

The method for inputting Chinese character with Easy-Strokes as described above, wherein the said six stroke types of Easy-Strokes comprise horizontal bar, vertical bar, slash, back slash, dot, and curve;

Wherein horizontal bar of Easy-Strokes represents any straight horizontal line in a Chinese character;

Wherein vertical bar of Easy-Strokes represents any straight vertical line in a Chinese character;

Wherein slash of Easy-Strokes represents any curved line roughly along the direction from top-right to bottom-left;

Wherein back slash of Easy-Strokes represents any curved line roughly along the direction from top-left to bottom-right;

Wherein dot of Easy-Strokes represents any short slanted line in a Chinese character;

Wherein curve of Easy-Strokes represents any curved line roughly along the direction from top-left to bottom-left in a Chinese character.

Wherein the said six stroke types of Easy-Strokes have the feature codes; wherein each of them has the corresponding key on the keyboard.

The method for inputting Chinese characters with Easy-Strokes as described above, wherein the feature codes for six stroke types of Easy-Strokes, “horizontal bar, vertical bar, slash, back slash, dot, curve” are “h, s, p, n, d, w” in Chinese system with corresponding keys of “H, S, P, N, D, W” on the keyboard respectively; wherein the feature codes for six stroke types of Easy-Stroke “horizontal bar, vertical bar, slash, back slash, dot, curve” are “h, v, s, b, d, c” in English system with corresponding keys of “H, V, S, B, D, C” on the keyboard respectively.

The method for inputting Chinese character with Easy-Strokes as described above, wherein the feature code for the total number of Easy-Strokes is “z” in Chinese system with corresponding key of “Z” on the keyboard; wherein the feature code for the total number of Easy-Stroke is “t” in English system with corresponding key of “T” on the keyboard.

The method for inputting Chinese characters with Easy-Strokes as described above, wherein the specific locations of a Chinese character include topmost, bottommost, leftmost and rightmost in a character.

The method for inputting Chinese characters with Easy-Strokes as described above, wherein the said input devices can comprise physical keyboard, virtual keyboard, image input equipment, and sound recognizer.

The method for inputting Chinese characters with Easy-Strokes as described above, wherein the method is implemented into cell phone, GPS navigator, computer, computer network, smart device, learning machine, portable commercial terminal using the method of inputting or searching Chinese characters with Easy-strokes.

A method for searching Chinese characters with Easy-Strokes, wherein comprising following steps:

Step I: Setting up a Chinese character database to identify the Chinese characters according to the stroke principle of Easy-Strokes, wherein a simple stroke without any angle (or vertex) is defined as one Easy-Stroke; wherein a complex stroke with at least one angle (or vertex) is separated, at the angle point(s) (or the vertices), into multiple simple strokes without any angle (or vertex), each said simple stroke is defined as one Easy-Stroke;

Step II: Searching Chinese characters from the Chinese character database by using the feature information of Easy-Strokes.

The method for searching Chinese characters with Easy-Strokes as described above, wherein the Chinese character database further comprising the feature codes for all stroke types of Easy-Strokes and the corresponding relationship between the feature codes for stroke types of Easy-Strokes at the special parts of Chinese characters and the special locations of the characters derived from Step I; wherein the searching in Step II is conducted by using the total number of Easy-Strokes in a Chinese character and the feature codes for stroke types of Easy-Strokes for at least one special part of the Chinese character to implement the search of Chinese characters.

The method for searching Chinese characters with Easy-Strokes as described above, wherein the Chinese characters database in Step I further comprising the feature codes for each stroke type of Easy-Strokes and the stroke number for each stroke type of Easy-Strokes; wherein the searching in Step II is conducted by using the feature codes for stroke types of Easy-Strokes and the stroke numbers corresponding to the stroke types of Easy-Strokes to implement the search of Chinese characters.

The method for searching Chinese characters with Easy-Strokes as described above, wherein the said six stroke types of Easy-Strokes comprise horizontal bar, vertical bar, slash, back slash, dot, and curve;

Wherein horizontal bar of Easy-Strokes represents any straight horizontal line in a Chinese character;

Wherein vertical bar of Easy-Strokes represents any straight vertical line in a Chinese character;

Wherein slash of Easy-Strokes represents any curved line roughly along the direction from top-right to bottom-left;

Wherein back slash of Easy-Strokes represents any curved line roughly along the direction from top-left to bottom-right;

Wherein dot of Easy-Strokes represents any short slanted line in a Chinese character;

Wherein curve of Easy-Strokes represents any curved line roughly along the direction from top-left to bottom-left in a Chinese character.

A method for searching Chinese characters with Easy-Strokes, wherein the said method is applied to Chinese dictionaries comprising following steps:

Step I: Setting up a Chinese character database to identify the Chinese characters according to the stroke principle of Easy-Strokes, wherein a simple stroke without any angle (or vertex) is defined as one Easy-Stroke; wherein a complex stroke with at least one angle (or vertex) is separated, at the angle point(s) (or the vertices), into multiple simple strokes without any angle (or vertex), each said simple stroke is defined as one Easy-Stroke;

Step II: Searching Chinese characters from the Chinese character database by using the feature information of Easy-Strokes; wherein the method for searching Chinese characters with Easy-Strokes is applied to Chinese dictionaries.

The method for inputting and searching Chinese characters with Easy-Strokes disclosed in this invention simplifies complex strokes of Chinese characters, and enables users to easily input and search Chinese characters without memorizing a large number of complex rules, and basic mapping knowledge between keyboard codes and root characters. In addition, its operation is simple and convenient because users may choose to input the feature information of Easy-Strokes for a Chinese character in any sequence and combination. Thus, both Chinese and non-Chinese can easily adopt the method.

### REALIZING THE INVENTION

The following description with the attached graphics explains this invention in detail in order to have technicians realize this invention according to reference manual.

This invention provides the method for inputting Chinese characters with Easy-Strokes, wherein comprising following steps:

Step I: According to the stroke principle of Easy-Strokes, a simple stroke without any angle (or vertex) is defined as one Easy-Stroke;

Step II: A complex stroke with at least one angle (or vertex) is separated, at the angle point(s) (or vertices), into multiple simple strokes without any angle (or vertex), each said simple stroke is defined as one Easy-Stroke;

Step III: Entering the total stroke number of Easy-Strokes derived from the Step I and Step II through a corresponding input component on an appropriate input device to implement the input of Chinese characters.

In order to simplify strokes of Chinese characters, all traditional complex strokes in Chinese characters can be broken down into simple strokes without any angle (or vertex). There are two kinds of situation in breaking down processing for strokes: some strokes in a Chinese character do not have any angle (or vertex), therefore this simple stroke can be used as an Easy-Stroke directly; other strokes in a Chinese character have angle(s) (or vertices) which are complex strokes, a complex stroke with at least one angle (or vertex) is separated, at the angle point(s) (or the vertices), into multiple simple strokes without any angle (or vertex), each said simple stroke is defined as one Easy-Stroke. It is necessary to clarify that Chinese characters mentioned in this invention include both simplified Chinese characters and traditional ones.

The method for inputting and searching Chinese characters with Easy-Strokes is not only used in applications of computer systems, but also applied to Chinese character index of a Chinese dictionary. The following is an example of computer applications to describe this invention.

To be easily used by user, Easy-Strokes can be described as six stroke types comprising horizontal bar, vertical bar, slash, back slash, dot, and curve. The above six types of Easy-Strokes are defined in Table 1.

TABLE 1
Definition of Six Types of Easy-Strokes

| Stroke | Symbol | Explanation | Example |
|---|---|---|---|
| Horizontal bar | Bar(H) | A straight horizontal line | [symbol] |
| Vertical bar | Bar(V) | A straight vertical line | [symbol] |
| Slash | Slash | A curved line roughly | [symbol] |
| | | along the direction from | [symbol] |
| | | top right to bottom left | |
| Back slash | Slash(B) | A curved line roughly | [symbol] |
| | | along the direction from | |
| | | top left to bottom right | |
| Dot | Dot | A short slanted line | [symbol] |
| Curve | Curve | A curved line roughly | [symbol] |
| | | along the direction from | |
| | | top-left to bottom-left | |

Note:
corresponding strokes are indicated in bold in the “Example” column.

In brief, the principal of the said method with Easy-Strokes is to have all complex strokes in Chinese characters become the angle-free (or vertex-free) strokes. Angle-free (or vertex-free) strokes significantly reduce the complexity of Chinese character strokes. Thus, all users can easily master and use strokes. Also, it effectively avoids confusions caused by the different understanding of Chinese character strokes between Chinese people and foreigners to count the stroke number of a Chinese character. Based on the principal of breaking down a complex stroke into multiple simple strokes, variable combinations of Easy-Strokes may be made, for example, five types of Easy-Strokes with horizontal bar, vertical bar, slash, back slash, and curve; the stroke type of dot may be merged into other type of Easy-Strokes. There are variable designs in practicing the principal of Easy-Strokes disclosed in this invention:

Easy-Strokes have feature codes. Also, feature codes correspond to keys on a computer keyboard. The code definitions of Easy-Strokes are shown in Table 2.

TABLE 2
Feature Codes of Easy-Strokes

| | | Chinese | | | English | | |
|---|---|---|---|---|---|---|---|
| | | Operating System | | | Operating System | | |
| Easy-Strokes | | | | Input | | | Input |
| No | Type | Code | Name | Form | Code | Name | Form |
| 1 | horizontal bar | h | héng | h## | h | horizontal bar | h## |
| 2 | vertical bar | s | silù | s## | v | vertical bar | v## |
| 3 | slash | p | pi\check{e} | p## | s | slash | s## |
| 4 | back slash | n | nà | n## | b | back slash | b## |
| 5 | dot | d | di\check{a}n | d## | d | dot | d## |
| 6 | curve | w | wān | w## | c | curve | c## |
| 7 | total | z | z\check{o}ng | z## | t | total | t## |

While inputting Chinese characters, users can enter feature codes and the stroke number of Easy-Strokes.

In the Chinese computer system, the first letter of the pinyin of the Chinese pronunciation for the desired Easy-Stroke type is used as its feature code, Code z (z\check{o}ng) is used as the total stroke number of Easy-Strokes; and each code corresponds to a key on the keyboard. In the English computer system, the first letter of the English name for the desired Easy-Stroke type is used as its feature code; Code t is used as the total stroke number of Easy-Strokes; and each code corresponds to a key on the keyboard.

While inputting Chinese characters, a user is searching all pre-stored Chinese characters in a computer system according to the specific rule of an input pattern of Easy-Strokes, and then selecting the matched character to output from the list of the current Chinese characters. There are seven main input patterns. The Chinese character [symbol] is used as an example to demonstrate each pattern.

The first pattern: the default sequence of Easy-Stroke types is setup in a computer system. The default sequence in a system can be horizontal bar, vertical bar, slash, back slash, dot, and curve. Stroke numbers for different stroke types of Easy-Strokes in a Chinese character are entered in the default sequence. The stroke number for each type of Easy-Strokes is between [00-99]. For example, the character [symbol] in this pattern is entered as “030101000100”, which means that this character is constructed with three horizontal bars, a vertical bar, a slash, and a dot. There is no back slash and curve.

The second pattern: entering the total stroke number of Easy-Strokes in a Chinese character and feature codes for stroke types of Easy-Strokes for at least one specific part of the Chinese character. The specific parts of a Chinese character include topmost, bottommost, leftmost and rightmost.

In an implemented case, feature codes of Easy-Stroke types representing the leftmost and topmost strokes in a Chinese character are selected and entered. These strokes are called the leftmost stroke and topmost stroke. In this case, the following three rules collaborate to operate principles of the input method of Chinese characters in this invention.

### Count One Stroke Per Angle (or Vertex)

In order to easily count the number of strokes in a Chinese character, the said method breaks down a complex angled-stroke (a traditional or old stroke) into multiple non-angled-strokes (a simple or new stroke). This rule is the key to implement the disclosed method in this invention. Typical examples are listed:

| Character | Old | New | Character | Old | New |
|---|---|---|---|---|---|
| [symbol] | 1 | 4 | [symbol] | 3 | 4 |
| [symbol] | 3 | 4 | [symbol] | 3 | 6 |
| [symbol] | 4 | 7 | [symbol] | 4 | 8 |
| [symbol] | 6 | 8 | [symbol] | 7 | 9 |

### Left First and Top Second

To narrow down selectable character set, the said method designates the leftmost stroke as the 1^{st} stroke and the topmost stroke as the 2^{nd} stroke if there are two or more strokes in the character. If two strokes are connected together, the leftmost stroke among the two has a higher priority for the selection. Typical examples are listed:

| Character | 1^{st} Stroke | 2^{nd} Stroke | Character | 1^{st} Stroke | 2^{nd} Stroke |
|---|---|---|---|---|---|
| [symbol] | Bar(H) | Bar(H) | [symbol] | Bar(V) | Bar(H) |
| [symbol] | Bar(H) | Dot | [symbol] | Bar(H) | Slash |
| [symbol] | Curve | Slash | [symbol] | Dot | Bar(V) |
| [symbol] | Dot | Dot | [symbol] | Slash | Bar(H) |

### One Stroke One Count

To obtain all the possible different graphical characteristics of a character and avoid one stroke being double counted, the leftmost stroke is considered as the 1^{st} stroke if the character has the same stroke in both the leftmost and topmost positions. The topmost stroke from the rest of strokes is designated as the 2^{nd} stroke. Typical examples are listed:

| Character | 1^{st} Stroke | 2^{nd} Stroke | Character | 1^{st} Stroke | 2^{nd} Stroke |
|---|---|---|---|---|---|
| [symbol] | Bar(V) | Dot | [symbol] | Bar(H) | Bar(V) |
| [symbol] | Bar(H) | Slash | [symbol] | Slash | Slash(B) |
| [symbol] | Slash | Slash | [symbol] | Slash | Bar(V) |
| [symbol] | Slash | Bar(H) | [symbol] | Bar(V) | Bar(V) |

The example of Character [symbol] in this pattern should be entered as “z6hs” in the Chinese computer system. Among the entered sequence, the “z6” stands for the total stroke number of six strokes in Character [symbol] . The leftmost stroke is a horizontal bar, and the topmost stroke is a vertical bar. Also, the sequence expresses the rule of the leftmost stroke first and topmost one second in any two consecutive input feature codes entered.

The third pattern: entering feature codes and corresponding stroke numbers for different types of Easy-Strokes in a character. The example of Character [symbol] in this pattern should be entered as “h3s1p1d1” in the Chinese computer system. The entered sequence means that there are three horizontal bars, a vertical bar, a slash and a dot.

The fourth pattern: entering the total stroke number of Easy-Strokes, feature codes and corresponding stroke numbers for different types of Easy-Strokes in a character. The example of Character [symbol] in this pattern should be entered as “z6h3s1p1d1” in the Chinese computer system. The entered sequence means that there are six strokes in total, three horizontal bars, a vertical bar, a slash and a dot.

The fifth pattern: entering feature codes for stroke types of Easy-Strokes for at least one specific part of the character, and feature codes with corresponding stroke numbers for different stroke types of Easy-Strokes in a character. The example of Character [symbol] in this pattern should be entered as “hsh3s1p1d1” in the Chinese computer system. The entered sequence means that the leftmost stroke is a horizontal bar, and the topmost stroke is a vertical bar. There are three horizontal bars, a vertical bar, a slash and a dot.

The sixth pattern: this pattern combines the second and third patterns to enter the total stroke number of Easy-Strokes, feature codes for stroke types of Easy-Strokes for at least one specific part of the character, and feature codes with corresponding stroke numbers for different stroke types of Easy-Strokes in a character. The example of Character [symbol] in this pattern should be entered as “z6hsh3s1 p1d 1” in the Chinese computer system. The “z6” stands for the total stroke number of six strokes in Character [symbol] The leftmost stroke is a horizontal bar, and the topmost stroke is vertical bar. The character has three horizontal bars, a vertical bar, a slash and a dot.

The seventh pattern: this pattern is to use an image device to acquire handwriting graphic, and convert the graphic into an Easy-Stroke through the pattern recognition system, and number of strokes, both into the third pattern. The example of Character [symbol] in this pattern should be drawn as three horizontal bars, a vertical bar, a slash and a dot.

The feature information of Chinese characters with Easy-Strokes includes four aspects: the total stroke number of Easy-Strokes, the stroke types of Easy-Strokes, the stroke types of Easy-Strokes at the special locations in a character, and the stroke numbers of different types of Easy-Strokes. The patterns of Chinese character input method are not limited to these seven patterns previously described. Furthermore, the feature information of Easy-Strokes can be entered based on the above seven patterns to narrow down selected characters with some special characteristics. The selected combinations and entering sequences of Easy-Strokes in the input method may not strictly follow the above seven patterns.

The method for inputting Chinese characters with Easy-Strokes as described above, wherein the said input device can be a number key or a combination of number keys as the input component on the keyboard for entering the stroke number for each stroke type of Easy-Strokes to implement the input of Chinese characters.

The method for inputting Chinese characters with Easy-Strokes as described above, wherein Step III further comprising: determining the feature codes for stroke types of Easy-Strokes derived from Step I and Step II, entering the total number of Easy-Strokes calculated from Step I and Step II and feature codes for stroke types of Easy-Strokes for at least one special location of the Chinese character through the input components on the keyboard to implement the input of Chinese characters.

The method for inputting Chinese characters with Easy-Strokes as described above, wherein Step III further comprising: determining feature codes for stroke types of Easy-Strokes and calculating the stroke numbers for different stroke types of Easy-Strokes derived from Step I and II, and entering feature codes for stroke types of Easy-Strokes with the corresponding stroke number for each stroke type through the input components on the keyboard to implement the input of Chinese characters.

The method for inputting Chinese characters with Easy-Strokes as described above, wherein Step III further comprising: determining feature codes for stroke types of Easy-Strokes and calculating the stroke numbers for different stroke types of Easy-Strokes derived from Step I and Step II, and entering the total number of Easy-Strokes in a Chinese character and feature codes for stroke types of Easy-Strokes with the corresponding stroke number for each stroke type through the input components on the keyboard to implement the input of Chinese characters.

The method for inputting Chinese characters with Easy-Strokes as described above, wherein Step III further comprising: determining feature codes for stroke types of Easy-Strokes and calculating the stroke numbers for different stroke types of Easy-Strokes derived from Step I and Step II, and entering feature codes for stroke types of Easy-Strokes with the corresponding stroke number for each stroke type and feature codes for stroke types of Easy-Strokes for at least one special location of the Chinese character through the input components on the keyboard to implement the input of Chinese characters.

The method for inputting Chinese characters with Easy-Strokes as described above, wherein Step III further comprising: determining feature codes for stroke types of Easy-Strokes and calculating the stroke numbers for different stroke types of Easy-Strokes and the total number of Easy-Strokes derived from Step I and Step II, and entering the total number of Easy-Strokes in a Chinese character, the feature codes for stroke types of Easy-Strokes for at least one special location of the Chinese character, and feature codes for stroke types of Easy-Strokes with the corresponding stroke number for each stroke type through the input components on the keyboard to implement the input of Chinese characters.

The method for inputting Chinese characters with Easy-Strokes as described above, wherein Step III further comprising: inputting hand-written image of Easy-Strokes derived from Step I and Step II by using an image input equipment, and identifying the number and type of Easy-Strokes with pattern recognition to implement the input of Chinese characters.

The method for inputting Chinese character with Easy-Strokes as described above, wherein the said six stroke types of Easy-Strokes comprise horizontal bar, vertical bar, slash, back slash, dot, and curve;

Wherein horizontal bar of Easy-Strokes represents any straight horizontal line in a Chinese character;

Wherein vertical bar of Easy-Strokes represents any straight vertical line in a Chinese character;

Wherein slash of Easy-Strokes represents any curved line roughly along the direction from top-right to bottom-left;

Wherein back slash of Easy-Strokes represents any curved line roughly along the direction from top-left to bottom-right;

Wherein dot of Easy-Strokes represents any short slanted line in a Chinese character;

Wherein curve of Easy-Strokes represents any curved line roughly along the direction from top-left to bottom-left in a Chinese character.

Wherein the said six stroke types of Easy-Strokes have the feature codes; wherein each of them has the corresponding key on the keyboard.

The method for inputting Chinese characters with Easy-Strokes as described above, wherein the feature codes for six stroke types of Easy-Strokes, “horizontal bar, vertical bar, slash, back slash, dot, curve” are “h, s, p, n, d, w” in Chinese system with corresponding keys of “H, S, P, N, D, W” on the keyboard respectively; wherein the feature codes for six stroke types of Easy-Stroke “horizontal bar, vertical bar, slash, back slash, dot, curve” are “h, v, s, b, d, c” in English system with corresponding keys of “H, V, S, B, D, C” on the keyboard respectively.

The method for inputting Chinese character with Easy-Strokes as described above, wherein the feature code for the total number of Easy-Strokes is “z” in Chinese system with corresponding key of “Z” on the keyboard; wherein the feature code for the total number of Easy-Stroke is “t” in English system with corresponding key of “T” on the keyboard.

The method for inputting Chinese characters with Easy-Strokes as described above, wherein the specific locations of a Chinese character include topmost, bottommost, leftmost and rightmost in a character.

The method for inputting Chinese characters with Easy-Strokes as described above, wherein the said input devices can comprise physical keyboard, virtual keyboard, image input equipment, and sound recognizer.

The method for inputting Chinese characters with Easy-Strokes as described above, wherein the method is implemented into cell phone, GPS navigator, computer, computer network, smart device, learning machine, portable commercial terminal using the method of inputting or searching Chinese characters with Easy-strokes.

A method for searching Chinese characters with Easy-strokes, wherein comprising following steps:

Step I: Setting up a Chinese character database to identify the Chinese characters according to the stroke principle of Easy-Strokes, wherein a simple stroke without any angle (or vertex) is defined as one Easy-Stroke; wherein a complex stroke with at least one angle (or vertex) is separated, at the angle point(s) (or the vertices), into multiple simple strokes without any angle (or vertex), each said simple stroke is defined as one Easy-Stroke;

Step II: Searching Chinese characters from the Chinese character database by using the feature information of Easy-Strokes.

The method for searching Chinese characters with Easy-Strokes as described above, wherein the Chinese character database further comprising: the feature codes for all stroke types of Easy-Strokes and the corresponding relationship between the feature codes for stroke types of Easy-Strokes at the special parts of Chinese characters and the special locations of the characters derived from Step I; wherein the searching in Step II is conducted by using the total number of Easy-Strokes in a Chinese character and the feature codes for stroke types of Easy-Strokes for at least one special part of the Chinese character to implement the search of Chinese characters.

The method for searching Chinese characters with Easy-Strokes as described above, wherein the Chinese characters database further comprising: the feature codes for each stroke type of Easy-Strokes and the stroke number for each stroke type of Easy-Strokes derived from Step I; wherein the searching in Step II is conducted by using the feature codes for stroke types of Easy-Strokes and the stroke numbers corresponding to the stroke types of Easy-Strokes to implement the search of Chinese characters.

The method for searching Chinese characters with Easy-Strokes as described above, wherein the said six stroke types of Easy-Strokes comprise horizontal bar, vertical bar, slash, back slash, dot, and curve;

Wherein horizontal bar of Easy-Strokes represents any straight horizontal line in a Chinese character;

Wherein vertical bar of Easy-Strokes represents any straight vertical line in a Chinese character;

Wherein slash of Easy-Strokes represents any curved line roughly along the direction from top-right to bottom-left;

Wherein back slash of Easy-Strokes represents any curved line roughly along the direction from top-left to bottom-right;

Wherein dot of Easy-Strokes represents any short slanted line in a Chinese character;

Wherein curve of Easy-Strokes represents any curved line roughly along the direction from top-left to bottom-left in a Chinese character.

A method for searching Chinese characters with Easy-Strokes, wherein the said method is applied to Chinese dictionaries comprising following steps:

Step I: Setting up a Chinese character database to identify the Chinese characters according to the stroke principle of Easy-Strokes, wherein a simple stroke without any angle (or vertex) is defined as one Easy-Stroke; wherein a complex stroke with at least one angle (or vertex) is separated, at the angle point(s) (or the vertices), into multiple simple strokes without any angle (or vertex), each defined as one Easy-Stroke;

Step II: Searching Chinese characters from the Chinese character database by using the feature information of Easy-Strokes; wherein the method for searching Chinese characters with Easy-Strokes is applied to Chinese dictionaries.

In the said method for inputting Chinese characters with Easy-Strokes, the said input device can be a number key or a combination of number keys as the input component on the keyboard to enter the stroke number for each stroke type of Easy-Strokes.

Comparing with the traditional stroke method, the Easy-Strokes method for inputting and searching Chinese characters has significantly improved the distribution of the numbers of characters on stroke counts. Data in Table 3 is the statistical result based on Chinese character set of the national standard of People's Republic of China, which contains 6,763 simplified Chinese characters. The fewer characters are on the number of distribution, the better to reduce repetition rate of characters, and improve the efficiency of Chinese character output. For Easy-Stroke method, the maximum value of characters is 658 in the set of 13 strokes; and for the traditional strokes method, the maximum value of characters is 748 in the set of 10 strokes. Hence, the Easy-Stroke method has the 12.0% less repetition rate on basic strengths than the traditional strokes method for inputting and searching Chinese characters.

TABLE 3
Distribution on numbers of Chinese characters
between Easy-Stroke method and traditional stroke method

| | # of Characters | | | # of Characters | |
|---|---|---|---|---|---|
| # of | Easy- | Traditional | # of | Easy- | Traditional |
| Strokes | Stroke | Stroke | Strokes | Stroke | Stroke |
| 1 | 4 | 5 | 18 | 303 | 75 |
| 2 | 10 | 34 | 19 | 224 | 75 |
| 3 | 30 | 78 | 20 | 189 | 44 |
| 4 | 74 | 142 | 21 | 131 | 26 |
| 5 | 91 | 207 | 22 | 91 | 16 |
| 6 | 148 | 341 | 23 | 55 | 13 |
| 7 | 208 | 533 | 24 | 48 | 6 |
| 8 | 300 | 677 | 25 | 28 | 6 |
| 9 | 436 | 740 | 26 | 21 | 1 |
| 10 | 575 | 748 | 27 | 14 | 0 |
| 11 | 609 | 692 | 28 | 8 | 0 |
| 12 | 605 | 640 | 29 | 3 | 0 |
| 13 | 658 | 522 | 30 | 5 | 1 |
| 14 | 561 | 400 | 31 | 3 | 0 |
| 15 | 498 | 310 | 32 | 2 | 0 |
| 16 | 471 | 257 | 33 | 2 | 0 |
| 17 | 356 | 174 | 34 | 2 | 0 |

Methods for inputting or searching Chinese characters with Easy-Strokes in this invention are not only suitable for Chinese language, but also can be used for Kanji of Japanese and Korean languages. In these cases, the corresponding type of Easy-Stroke should be based on character decompositions of the particular language.

The method for inputting Chinese characters with Easy-Stroke relies on computer software, which will process Chinese characters input and search. Actually, processes of inputting and searching Chinese characters in a computer system are basically same.

This computer software can be divided into two parts: data structure and functional program. Data structure is designated to prepare data which will be used by the functional program. Two key data structures are the Feature Code Table (Table 4) of Chinese character Easy-Strokes and the Current Chinese Character Table (Table 5). The Feature Code Table records the feature information of Easy-Strokes for Chinese characters. This table is also used as the database for searching Chinese character. The above feature information of Easy-Strokes for a Chinese character consists of the total stroke number of Easy-Strokes, the stroke types of Easy-Strokes, the stroke types of Easy-Strokes at the special locations of a character, and the stroke numbers of different types of Easy-Strokes. The feature information of Easy-Strokes to be entered can be different depending on the selected input or search stroke sets. The data item of stroke set is to satisfy users with different customs for input or search. This design allows a character to have multiple stroke sets with more flexibility, thus making it more users friendly. The total stroke number of East-Strokes is not independent data; it is equal to the sum of all stroke numbers of six Easy-Stroke types. This redundant data in the Feature Code Table is to avoid re-calculation, and to improve search performance. In addition, Character ID can uniquely identify a record.

TABLE 4
The Feature Code Table

| Data Item | Data Type | Description |
|---|---|---|
| Character ID | Integer | Identifier of a Chinese character |
| Character | String | Chinese character |
| StrokeSet | Integer | Stroke set of the character |
| Leftmost | String | Easy-Stroke type of the leftmost stroke |
| Topmost | String | Easy-Stroke type of the topmost stroke |
| Horizontal Bar | Integer | The number of Easy-Stroke horizontal bar |
| Vertical Bar | Integer | The number of Easy-Stroke vertical bar |
| Slash | Integer | The number of Easy-Stroke slash |
| Back Slash | Integer | The number of Easy-Stroke back slash |
| Dot | Integer | The number of Easy-Stroke dot |
| Curve | Integer | The number of Easy-Stroke curve |
| Total | Integer | Total number of Easy-Strokes |

The Current Chinese Character Table records the latest matched Chinese characters as candidates for selection. It contains available Chinese characters for selection only through the interface as shown in Table 5. This data structure has two functions. Firstly, it provides the narrow scope of Chinese characters for selection. Secondly, it cooperates with the Feature Code Table to search progressively for the target character.

TABLE 5
Current Chinese Character Table

| Data Item | Data Type | Description |
|---|---|---|
| Character ID | Integer | Identifier of a Chinese character |
| Character | String | Chinese character |

The functional program runs logical steps to input Chinese characters on the basis of the above data structures. The typical data processing pathway is as follows: Input→Processing→Output. Method for inputting and searching Chinese characters with Easy-Strokes in this invention provides mechanism to input and search Chinese characters, and includes computer interfaces and codes to be entered. This procedure processes the Current Chinese Character Table, searching characters, and the Feature Code Table. Wherein, the Current Chinese Character Table will be initialized when a new Chinese character is entered. In other words, all Chinese characters are recorded into the Current Chinese Character Table for initialization, i.e. all characters are selectable candidate characters in the Current Chinese Character Table. The program then searches the wanted Chinese character in Current Chinese Character Table, and filters those characters which are not matched with the entered Easy-Stroke information of the character, and keeps the rest of the matched characters.

In general, operating steps of methods for inputting and searching Chinese characters are shown in Table 6.

TABLE 6
General steps of methods for inputting and searching Chinese characters

| Step | User Operations | System Responses |
|---|---|---|
| 1 | According to any stroke set to enter | Search Chinese characters in Current Chinese |
| | one or more feature codes of | Character Table, and generate a new Current |
| | Easy-Strokes for a Chinese character; | Chinese Character Table with all characters |
| | | which match the feature codes in Step 1 for |
| | | selection; |
| 2 | According to the stroke set, enter one | Search Chinese characters in Current Chinese |
| | or more feature codes of Easy-Strokes | Character Table, and generate a new Current |
| | for the Chinese character | Chinese Character Table with all characters |
| | continuously; | which match the feature codes in Step 2 for |
| | | selection; |
| 3 | Repeat Step 2 as needed; | Search Chinese characters in Current Chinese |
| | | Character Table, and generate a new Current |
| | | Chinese Character Table with all characters |
| | | which match the feature codes in Step 2 for |
| | | selection; |
| 4 | Select and confirm the wanted | Provide related information of the selected |
| | Chinese character. | Chinese character. |

Also, there are two processes to search Chinese characters based on different interfaces in the method for searching Chinese characters with Easy-Strokes: one-time searching and multi-time searching. One-time searching is to enter all feature codes of the wanted Chinese character, then search at one time and filter matched characters. This process is suitable to enter the information for DOS interface. Multi-time searching is to enter one item of feature codes in multiple times, and filter matched characters gradually. This process is suitable to enter the information and seek dynamically for graphical user interfaces (GUI).

The invention of the method for searching Chinese characters with Easy-Strokes also can be used for Chinese character index in printed media. For example: selecting the specific sequence and combination from feature information of Chinese characters such as the total stroke number of Easy-Strokes, and leftmost and topmost stroke types to make the index of Chinese characters. To implement the procedure of searching Chinese characters, all Chinese characters are grouped by the total stroke numbers in the same group, the characters are sorted in stroke sections of leftmost and topmost strokes; pinyin is used as searched results. To use it, a user first counts the total stroke number of Easy-Strokes for a Chinese character; then seeks the stroke section of leftmost and topmost in the same stroke number group; lastly sequentially looks for the wanted character. The processing steps to use the printed index of Chinese characters with Easy-Strokes are shown in Table 7.

TABLE 7
Steps of Chinese character indexing method in publication media

| Step | User Operations |
|---|---|
| 1 | In a stroke set, calculate the total stroke number of a |
| | Chinese character with Easy-Strokes, and then locate |
| | to the character section of the respective stroke number; |
| 2 | Identify Easy-Stroke types at the specific locations |
| | of leftmost and topmost in the wanted Chinese character, |
| | and then locate the respective stroke section of the |
| | corresponding stroke types according to a stroke set; |
| 3 | Find and select the wanted Chinese character. |

The index of Chinese characters with Easy-Strokes in printed media is demonstrated as below:

| | | | | | |
|---|---|---|---|---|---|
| | jìn | [symbol] | kān | [symbol] | xīng |
| [symbol] | sháo | [symbol] | shuāng | | xìng |
| [symbol] | jī | [symbol] | [symbol] | [symbol] | bīng |
| | j\check{i} | [symbol] | wéi | | bìng |
| [symbol] | ch\check{e} | [symbol] | yá | [symbol] | guān |
| | ch\check{i} | [symbol] | yú | [symbol] | ch\check{a}n |
| [symbol] | qiàn | | y\check{u} | [symbol] | jiāo |
| [symbol] | [symbol] | | yù | [symbol] | qí |
| [symbol] | shēng | [symbol] | zhuān | [symbol] | fù |
| [symbol] | shì | [symbol] | Jū | [symbol] | jì |
| [symbol] | bèi | | qi\check{e} | [symbol] | rèn |
| [symbol] | piān | [symbol] | shì | [symbol] | fāng |
| | piàn | [symbol] | zhū | [symbol] | yáng |
| [symbol] | [symbol] | [symbol] | J\check{i} | [symbol] | [symbol] |
| [symbol] | fá | [symbol] | gòng | [symbol] | yāng |
| [symbol] | yí | [symbol] | qù | [symbol] | gā |
| [symbol] | hù | [symbol] | guī | | jiā |
| [symbol] | [symbol] | [symbol] | bā | | jiá |
| [symbol] | qiān | | pá | [symbol] | dān |
| [symbol] | zhàng | [symbol] | pū | [symbol] | hū |
| [symbol] | f\check{a}n | [symbol] | jiān | [symbol] | pāng |
| [symbol] | xiāng | [symbol] | g\check{u} | [symbol] | pīng |
| [symbol] | chì | [symbol] | Y\check{i} | [symbol] | qiáo |
| [symbol] | [symbol] | [symbol] | piáo | [symbol] | wéi |
| [symbol] | gōng | | pō | | wèi |
| [symbol] | jīn | | pò | [symbol] | wán |
| [symbol] | [symbol] | | p\check{u} | [symbol] | bàn |
| [symbol] | [symbol] | [symbol] | dàn | [symbol] | zài |
| [symbol] | hù | [symbol] | shu\check{i} | [symbol] | yōu |
| [symbol] | wú | [symbol] | m\check{i}n | [symbol] | yòu |
| [symbol] | y\check{a} | [symbol] | Jī | [symbol] | máo |
| [symbol] | kuī | [symbol] | \check{e}r | [symbol] | huī |
| [symbol] | shì | [symbol] | m\check{i} | [symbol] | dàn |
| [symbol] | yuán | [symbol] | [symbol] | | shí |

The method for indexing Chinese character with Easy-Stroke simplifies the index of a current-published Chinese dictionary from three steps of “radical→characters→definition” into two steps of “characters→definition”, thus making it easier to master and use. This practice can be applied into indexes of Chinese dictionaries and Chinese-other language dictionaries, as well as Chinese teaching materials, including electronic publications.

The input technological core program of the invention can be used to build the Application Programming Interfaces (API), which is able to be used in a variety of operating software or applications in smart devices such as applications of mobile communications devices (including cellular phones, GPS navigators), computer networks (including Internet), as well as a variety of other computer systems (including smart devices, notebook computers, laptop).

The implementation of this invention as disclosed above is not limited to the applied cases in this description. This invention can be applied to a variety of suitable fields. It is easily modified by the people skilled in those fields. Therefore under the requirements of these claims and the general concepts of equivalent scope, this invention is not limited by specific of details and descriptions as shown here.

1. A method for inputting Chinese characters with Easy-Strokes, wherein comprising following steps:
Step I: According to the stroke principle of Easy-Strokes, a simple stroke without any angle (or vertex) is defined as one Easy-Stroke;
Step II: A complex stroke with at least one angle (or vertex) is separated, at the angle point(s) (or vertices), into multiple simple strokes without any angle (or vertex), each said simple stroke is defined as one Easy-Stroke;
Step III: Entering the total stroke number of Easy-Strokes derived from the Step I and Step II through a corresponding input component on an appropriate input device to implement the input of Chinese characters.

2. The method for inputting Chinese characters with Easy-Strokes as described in claim 1, wherein the said input device can be a number key or a combination of number keys as the input component on the keyboard for entering the stroke number for each stroke type of Easy-Strokes to implement the input of Chinese characters.

3. The method for inputting Chinese characters with Easy-Strokes as described in claim 1, wherein Step III further comprising: determining the feature codes for stroke types of Easy-Strokes derived from Step I and Step II, entering the total number of Easy-Strokes calculated from Step I and Step II and the feature codes for stroke types of Easy-Strokes for at least one special location of the Chinese character through the input components on the keyboard to implement the input of Chinese characters.

4. The method for inputting Chinese characters with Easy-Strokes as described in claim 1, wherein Step III further comprising: determining the feature codes for stroke types of Easy-Strokes and calculating the stroke numbers for different stroke types of Easy-Strokes derived from Step I and II, and entering the feature codes for stroke types of Easy-Strokes with the corresponding stroke number for each stroke type through the input components on the keyboard to implement the input of Chinese characters.

5. The method for inputting Chinese characters with Easy-Strokes as described in claim 1, wherein Step III further comprising: determining the feature codes for stroke types of Easy-Strokes and calculating the stroke numbers for different stroke types of Easy-Strokes derived from Step I and Step II, and entering the total number of Easy-Strokes in a Chinese character and the feature codes for stroke types of Easy-Strokes with the corresponding stroke number for each stroke type through the input components on the keyboard to implement the input of Chinese characters.

6. The method for inputting Chinese characters with Easy-Strokes as described in claim 1, wherein Step III further comprising: determining the feature codes for stroke types of Easy-Strokes and calculating the stroke numbers for different stroke types of Easy-Strokes derived from Step I and Step II, and entering the feature codes for stroke types of Easy-Strokes with the corresponding stroke number for each stroke type and the feature codes for stroke types of Easy-Strokes for at least one special location of the Chinese character through the input components on the keyboard to implement the input of Chinese characters.

7. The method for inputting Chinese characters with Easy-Strokes as described in claim 1, wherein Step III further comprising: determining the feature codes for stroke types of Easy-Strokes and calculating the stroke numbers for different stroke types of Easy-Strokes and the total number of Easy-Strokes derived from Step I and Step II, and entering the total number of Easy-Strokes in a Chinese character, the feature codes for stroke types of Easy-Strokes for at least one special location of the Chinese character, and the feature codes for stroke types of Easy-Strokes with the corresponding stroke number for each stroke type through the input components on the keyboard to implement the input of Chinese characters.

8. The method for inputting Chinese characters with Easy-Strokes as described in claim 1, wherein Step III further comprising: inputting hand-written image of Easy-Strokes derived from Step I and Step II by using an image input equipment, and identifying the number and type of Easy-Strokes with pattern recognition to implement the input of Chinese characters.

9. The method for inputting Chinese character with Easy-Strokes as described in claim 3 or 4 or 5 or 6 or 7 or 8, wherein the said six stroke types of Easy-Strokes comprise horizontal bar, vertical bar, slash, back slash, dot, and curve;
Wherein horizontal bar of Easy-Strokes represents any straight horizontal line in a Chinese character;
Wherein vertical bar of Easy-Strokes represents any straight vertical line in a Chinese character;
Wherein slash of Easy-Strokes represents any curved line roughly along the direction from top-right to bottom-left;
Wherein back slash of Easy-Strokes represents any curved line roughly along the direction from top-left to bottom-right;
Wherein dot of Easy-Strokes represents any short slanted line in a Chinese character;
Wherein curve of Easy-Strokes represents any curved line roughly along the direction from top-left to bottom-left in a Chinese character.
Wherein the said six stroke types of Easy-Strokes have the feature codes; wherein each of them has the corresponding key on the keyboard.

10. The method for inputting Chinese characters with Easy-Strokes as described in claim 9, wherein the feature codes for six stroke types of Easy-Strokes, “horizontal bar, vertical bar, slash, back slash, dot, curve” are “h, s, p, n, d, w” in Chinese system with corresponding keys of “H, S, P, N, D, W” on the keyboard respectively; wherein the feature codes for six stroke types of Easy-Stroke “horizontal bar, vertical bar, slash, back slash, dot, curve” are “h, v, s, b, d, c” in English system with corresponding keys of “H, V, S, B, D, C” on the keyboard respectively.

11. The method for inputting Chinese character with Easy-Strokes as described in claim 3 or 5 or 7, wherein the feature code for the total number of Easy-Strokes is “z” in Chinese system with corresponding key of “Z” on the keyboard; wherein the feature code for the total number of Easy-Stroke is “t” in English system with corresponding key of “T” on the keyboard.

12. The method for inputting Chinese characters with Easy-Strokes as described in claim 3 or 6 or 7, wherein the specific locations of a Chinese character include topmost, bottommost, leftmost and rightmost in a character.

13. The method for inputting Chinese characters with Easy-Strokes as described in claim 1, wherein the said input devices can comprise physical keyboard, virtual keyboard, image input equipment, and sound recognizer.

14. The method for inputting Chinese characters with Easy-Strokes as described in claim 1, wherein the method is implemented into cell phone, GPS navigator, computer, computer network, smart device, learning machine, portable commercial terminal using the method of inputting or searching Chinese characters with Easy-strokes.

15. A method for searching Chinese characters with Easy-strokes, wherein comprising following steps:
Step I: Setting up a Chinese character database to identify the Chinese characters according to the stroke principle of Easy-Strokes, wherein a simple stroke without any angle (or vertex) is defined as one Easy-Stroke; wherein a complex stroke with at least one angle (or vertex) is separated, at the angle point(s) (or the vertices), into multiple simple strokes without any angle (or vertex), each said simple stroke is defined as one Easy-Stroke;
Step II: Searching Chinese characters from the Chinese character database by using the feature information of Easy-Strokes.

16. The method for searching Chinese characters with Easy-Strokes as described in claim 15, wherein the Chinese character database further comprising: the feature codes for all stroke types of Easy-Strokes and the corresponding relationship between the feature codes for stroke types of Easy-Strokes at the special locations of Chinese characters and the special locations of the characters derived from Step I; wherein the searching in Step II is conducted by using the total number of Easy-Strokes in a Chinese character and the feature codes for stroke types of Easy-Strokes for at least one special location of the Chinese character to implement the search of Chinese characters.

17. The method for searching Chinese characters with Easy-Strokes as described in claim 15, wherein the Chinese characters database further comprising: the feature codes for each stroke type of Easy-Strokes and the stroke number for each stroke type of Easy-Strokes derived from Step I; wherein the searching in Step II is conducted by using the feature codes for stroke types of Easy-Strokes and the stroke numbers corresponding to the stroke types of Easy-Strokes to implement the search of Chinese characters.

18. The method for searching Chinese characters with Easy-Strokes as described in claim 15, wherein the said six stroke types of Easy-Strokes comprise horizontal bar, vertical bar, slash, back slash, dot, and curve;
Wherein horizontal bar of Easy-Strokes represents any straight horizontal line in a Chinese character;
Wherein vertical bar of Easy-Strokes represents any straight vertical line in a Chinese character;
Wherein slash of Easy-Strokes represents any curved line roughly along the direction from top-right to bottom-left;
Wherein back slash of Easy-Strokes represents any curved line roughly along the direction from top-left to bottom-right;
Wherein dot of Easy-Strokes represents any short slanted line in a Chinese character;
Wherein curve of Easy-Strokes represents any curved line roughly along the direction from top-left to bottom-left in a Chinese character.

19. A method for searching Chinese characters with Easy-strokes, wherein the said method is applied to Chinese dictionaries comprising following steps:
Step I: Setting up a Chinese character database to identify the Chinese characters according to the stroke principle of Easy-Strokes, wherein a simple stroke without any angle (or vertex) is defined as one Easy-Stroke; wherein a complex stroke with at least one angle (or vertex) is separated, at the angle point(s) (or the vertices), into multiple simple strokes without any angle (or vertex), each said simple stroke is defined as one Easy-Stroke;
Step II: Searching Chinese characters from the Chinese character database by using the feature information of Easy-Strokes; wherein the method for searching Chinese characters with Easy-Strokes is applied to Chinese dictionaries.
